(19) United States
(12) Patent Application Publication
(10) Pub. No.: US 2012/0148702 A1
(43) Pub. Date: Jun. 14, 2012

(54) EXTRUDER DIE ASSEMBLY

(76) Inventors: Michael Worth Herndon, Parkton, NC (US); Donald Van Earnest, Four Oaks, NC (US); Kenneth Eugene Day, Fayetteville, NC (US); Ernest Wilford Looman, JR., Tallmadge, OH (US)

(21) Appl. No.: 12/965,005

(22) Filed: Dec. 10, 2010

(51) Int. Cl. B29C 47/38

(52) U.S. Cl. 425/209

(57) ABSTRACT

A die assembly for use with an extruder is disclosed. The die assembly has a preformer die having a preformer shaped hole for forming the desired shape of a component to be extruded, wherein the shaped hole is not symmetrical and has a small first end and a large second end. The die assembly further includes a final die plate having a final shaping hole, the final shaping hole is not symmetrical and has a large first end and a small second end. The preformer die and the final die plate are positioned adjacent each other wherein the small first end of the preformer shaped hole is aligned with the large first end of the final shaping hole, and wherein the large second end of the preformer shaped hole is aligned with the small second end of the final shaping hole.

### FIELD OF THE INVENTION

The invention relates to the field of tire manufacturing, and more particularly to tire component manufacturing.

### BACKGROUND OF THE INVENTION

In tire manufacturing, numerous tire components are formed of a plurality of rubber parts. Rubber tire components such as the tire apex, sidewall, and tread are formed by an extrusion process. One type of extruder typically used in tire manufacturing is a screw extruder. The screw extruder typically has a long chamber with a screw centered in the channel, wherein the screw masticates the rubber. The end of the channel typically has a die having a hole formed therein. The shape of the hole dictates the cross-sectional shape of the rubber part to be made. The extruder pressure forces the rubber through the small die hole forming the part to be made in a continuous manner. The desired rubber part is obtained by cutting the extruded part to a given length.

Some rubber tire components can be more challenging to manufacture. An apex has a triangular cross-sectional shape that is extruded into a linear piece having the desired triangular cross-section. Depending upon the tire application, some apexes have triangular cross-sections which are tall and thin. Since the shape of the die mimics the shape of the desired rubber component, the die hole also has a thicker region and a much thinner region. The rubber tends to follow the path of least resistance, which means that the rubber does not want to flow into the thin region of the die. This can result in malformed apex articles that must be scrapped. Thus it is desired to have an improved die and method of manufacturing complex rubber articles.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

### BRIEF DESCRIPTION OF THE DRAWINGS

The invention will be described by way of example and with reference to the accompanying drawings in which:

FIG. 1 is a cross-sectional view of a schematic of a screw extruder;

FIG. 2 is a front view of the conventional sub components of the die for use in the extruder of FIG. 1;

FIG. 3 is a side view of the sub-components of the die of FIG. 2;

FIG. 4 is a front view of the final die plate of the present invention;

FIG. 5 is a front view of the preformer plate of the present invention;

FIG. 6 is a cross-sectional view of the preformer plate in the direction 6-6 of FIG. 5; and

FIG. 7 is a cross-sectional view of the preformer plate in the direction 7-7 of FIG. 5.

### DETAILED DESCRIPTION OF THE INVENTION

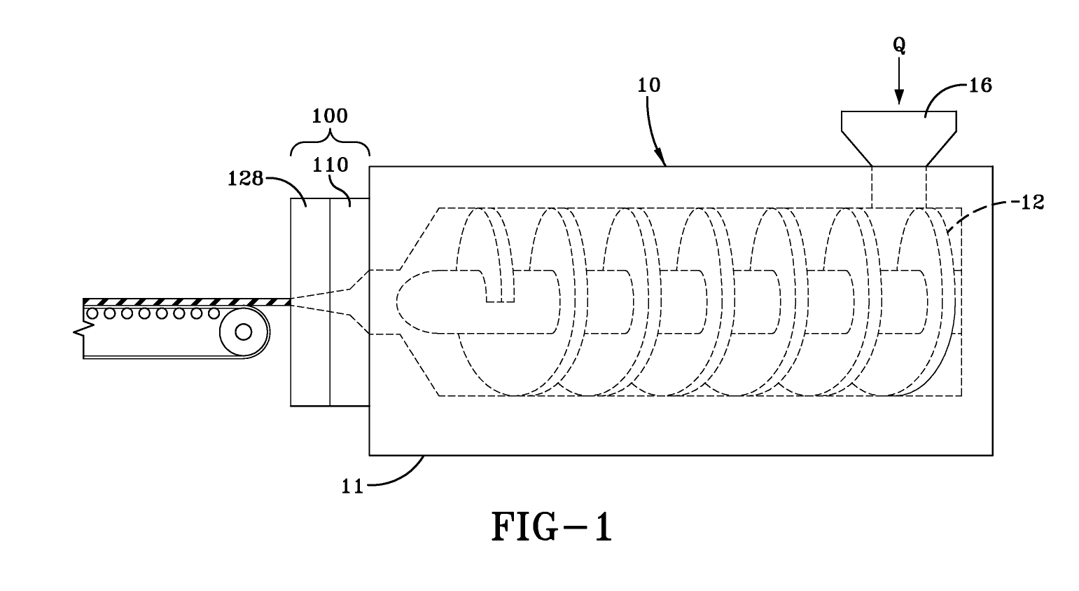

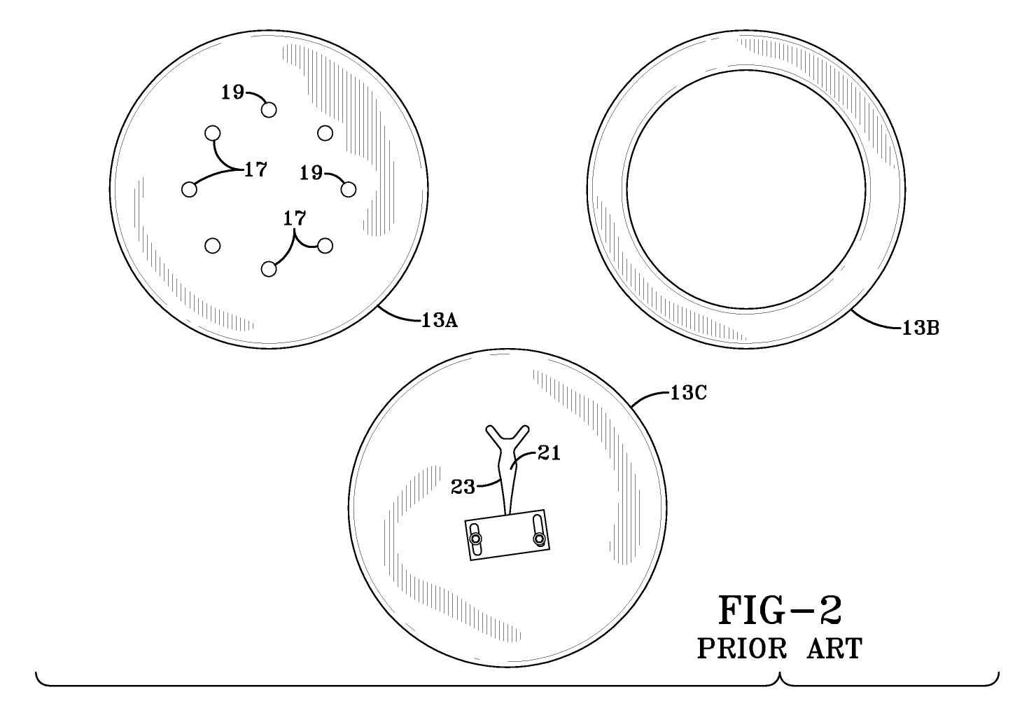

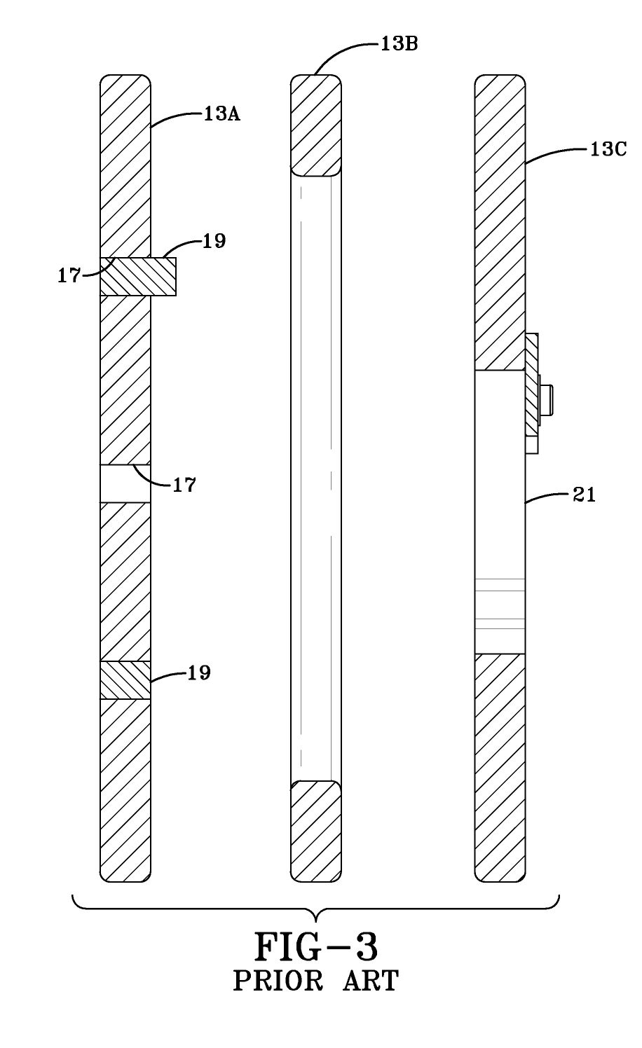

FIG. 1 illustrates an extruder 10 useful for extruding rubber articles and the like. The extruder 10 is comprised of a cylindrically shaped body 11 that houses an internal screw 12. The extruder is arranged such that a rubber material Q is fed into the main body portion 11 via a hopper 16. As the screw 12 rotates, the rubber is advanced forward through the main body. The rubber is masticated as it is worked on via the screw. The rubber is then passed through a preformer 110 and a die 128 before exiting the extruder outlet. A prior art die assembly is shown in FIG. 2, and is comprised of a pressure plate 13A, a intermediate chamber 13B, and a final die plate 13C. The pressure plate 13A is comprised of a flat disk having multiple holes 17. The holes are unplugged or plugged by trial and error in an attempt to direct the flow of rubber. The rubber then passes through an intermediate chamber 13B. The intermediate chamber is a blank disk forming an empty passageway that the rubber expands into. The rubber travels from the intermediate chamber 13B into a final shaping die 13C. The shaping die 13C is a flat plate having a shaped hole 21 which forms the final shape of the rubber article. The shaped hole 21 as shown can be used to form a triangular shaped apex having a thin tip. The invention is not limited to this shape or tire component, and can be used to form other shapes. Pins 19 can be arranged in the pressure plate to try and direct the rubber flow through the narrow passageway 23 forming the thin tip. The problem with the prior art setup is that it requires trial and error and lacks any positive control over the flow.

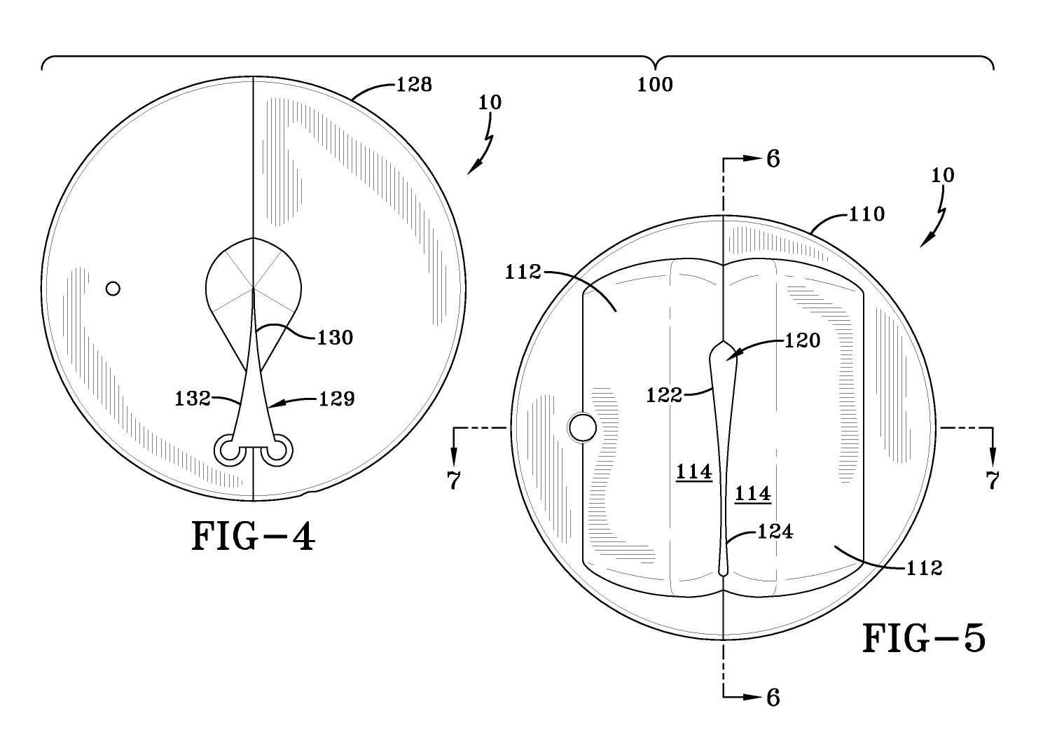

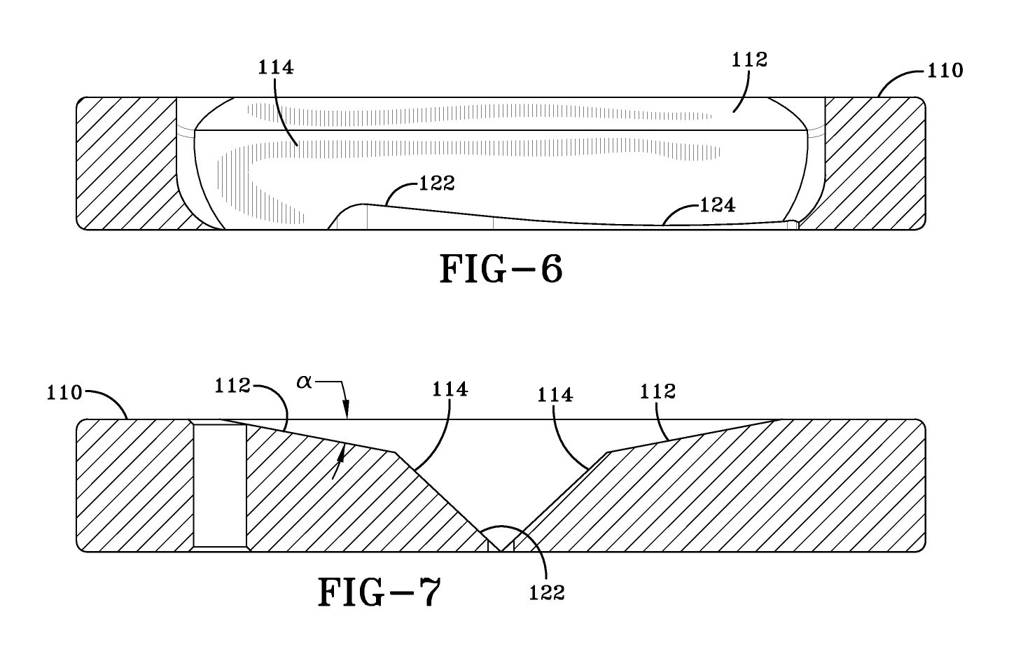

The die assembly 100 of the present invention is shown in FIGS. 4 and 5. The pressure plate 13A and intermediate chamber 13B is replaced by the preformer plate 110. The preformer plate 110 is formed of a round disk having a shaped hole 120 for forming the desired shape of an apex or other tire component. A first beveled portion 114 completely surrounds the shaped hole 120 and functions as a funnel to direct the rubber into the shaped hole 120. The preformer plate further comprises an optional second beveled portion 112 that is located adjacent the first beveled portion. Preferably, the second beveled portion 112 completely surrounds the first beveled portion. Preferably, the angle of inclination of the second beveled portion 112 is less than the angle of inclination of the first portion 114. The angle of inclination α is measured with respect to the flat plane of the upper surface of the plate. Thus the first and second beveled portions work together to funnel the rubber flow into the preformer hole 120.

It is important to note that the shape of the preformer hole 120 is an important aspect of the invention. As shown in FIG. 5, the preformer hole 120 has a large bulbous end 122 and a long thin end 124 opposite the bulbous end. The preformer functions to direct a large mass of rubber through the bulbous end 122 of the preformer plate 110 which is aligned for reception into the narrow passageway 130 of the final die plate 128. Thus the large bulbous end 122 of the preformer functions to load the rubber for entry into the long thin end 130. The long thin end 124 of the preformer hole is in alignment with a large bulbous end 132 of the die hole. Thus the preformer hole shape is rotated 180 degrees out of phase with the final die hole shape 129.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An extruder comprising: a body having an inlet end and an outlet end and an internal passageway in fluid communication with the inlet end and the outlet end, a screw rotatably mounted within the internal passageway, and a die assembly connected to the outlet end, the die assembly having a preformer die having a preformer shaped hole for forming the desired shape of a component to be extruded, wherein the shaped hole has a thin first end and an enlarged second end; the die assembly further comprising a final die plate having a final shaping hole, the final shaping hole having an enlarged first end and a thin second end, wherein the preformer die and the final die plate are positioned adjacent each other wherein the thin first end of the preformer shaped hole is aligned with the enlarged first end of the final shaping hole, and wherein the enlarged second end of the preformer shaped hole is aligned with the thin second end of the final shaping hole.

2. The extruder of claim 1 wherein the preformer shaped hole is surrounded by a first beveled portion.

3. The extruder of claim 2 wherein the first beveled portion is surrounded by a second beveled portion.

4. The extruder of claim 3 wherein the angle of inclination of the first beveled portion is greater than the angle of inclination of the second beveled portion.

5. An extruder comprising: a body having an inlet end and an outlet end and an internal passageway in fluid communication with the inlet end and the outlet end, a screw rotatably mounted within the internal passageway, and a die assembly connected to the outlet end, the die assembly having a preformer die having a preformer shaped hole for forming the desired shape of a component to be extruded, wherein the shaped hole is not symmetrical and has a small first end and a large second end; the die assembly further comprising a final die plate having a final shaping hole, the final shaping hole is not symmetrical and has a large first end and a small second end, wherein the preformer die and the final die plate are positioned adjacent each other wherein the small first end of the preformer shaped hole is aligned with the large first end of the final shaping hole, and wherein the large second end of the preformer shaped hole is aligned with the small second end of the final shaping hole.

6. A die assembly for use with an extruder, the die assembly having a preformer die having a preformer shaped hole for forming the desired shape of a component to be extruded, wherein the shaped hole is not symmetrical and has a small first end and a large second end; the die assembly further comprising a final die plate having a final shaping hole, the final shaping hole is not symmetrical and has a large first end and a small second end, wherein the preformer die and the final die plate are positioned adjacent each other wherein the small first end of the preformer shaped hole is aligned with the large first end of the final shaping hole, and wherein the large second end of the preformer shaped hole is aligned with the small second end of the final shaping hole.

7. The die assembly of claim 6 wherein the preformer shaped hole is surrounded by a first beveled portion.

8. The die assembly of claim 7 wherein the first beveled portion is surrounded by a second beveled portion.

9. The die assembly of claim 8 wherein the angle of inclination of the first beveled portion is greater than the angle of inclination of the second beveled portion.
